(19) United States
(12) Patent Application Publication
(10) Pub. No.: US 2021/0181467 A1
(43) Pub. Date: Jun. 17, 2021

(54) THREE-PIECE INFRARED SINGLE WAVELENGTH LENS SYSTEM

(71) Applicant: NEWMAX TECHNOLOGY CO., LTD., TAICHUNG CITY (TW)

(72) Inventor: Kun-Rui WU, TAICHUNG CITY (TW)

(21) Appl. No.: 17/189,220

(22) Filed: Mar. 1, 2021

Related U.S. Application Data
(63) Continuation of application No. 16/233,022, filed on Dec. 26, 2018.

(51) Int. Cl. G02B 13/00; G02B 9/12

(52) U.S. Cl. CPC G02B 13/008; G02B 9/12; G02B 13/0035

(57) ABSTRACT

A three-piece infrared single wavelength lens system includes, in order from the object side to the image side: a first lens element with a negative refractive power having an object-side surface being convex near an optical axis and an image-side surface being concave near the optical axis, a stop, a second lens element with a positive refractive power having an image-side surface being convex near the optical axis, at least one of an object-side and the image-side surfaces of the second lens element being aspheric, a third lens element with a refractive power having an object-side surface being convex near the optical axis and an image-side surface being concave near the optical axis, at least one of the object-side and the image-side surfaces of the second and third lens elements being aspheric. Such a system has a wide field of view, large stop, short length and less distortion.

### CROSS REFERENCE TO RELATED APPLICATION

This application is a continuation of U.S. patent application Ser. No. 16/233,022, which claims the earlier filing date of Dec. 26, 2018, the entire specification of which is incorporated herein by reference.

### BACKGROUND

### Field of the Invention

The present invention relates to a lens system, and more particularly to a miniaturized three-piece infrared single wavelength lens system applicable to electronic products.

### Description of the Prior Art

Nowadays digital imaging technology is constantly innovating and changing, in particular, digital carriers, such as, digital camera and mobile phone and so on, have become smaller in size, so CCD (Charge Coupled Device) or CMOS (Complementary Metal Oxide Semiconductor) sensor is also required to be more compact. In addition to be used in the field of photography, in recent years, infrared focusing lens has also be used in infrared receiving and sensing field of the game machine, and in order to make the scope of game machine induction user more broader, wide-angle lens group has become the mainstream for receiving infrared wavelength at present.

The applicant has also put forward a number of lens groups related to infrared wavelength reception, however, at present, the game machine is based on a more three-dimensional, real and immediate 3D game, the current or the applicant's previous lens groups are all 2D plane games, which cannot meet the 3D game focusing on the deep induction efficacy.

Special infrared receiving and induction lens groups for game machines are made of plastic for the pursuit of low cost, however, poor material transparency is one of the key factors that affect the depth detection accuracy of the game machine, and plastic lenses are easy to overheat or too cold in ambient temperature, so that the focal length of the lens group will be changed and cannot focus accurately. Therefore, the current infrared receiving and induction lens groups cannot meet the 3D game depth precise induction requirement.

The present invention mitigates and/or obviates the aforementioned disadvantages.

### SUMMARY

The primary objective of the present invention is to provide a three-piece infrared single wavelength lens system which has a wide field of view, large stop, short length and less distortion.

Therefore, a three-piece infrared single wavelength lens system in accordance with the present invention comprises, in order from an object side to an image side: a first lens element with a negative refractive power having an object-side surface being convex near an optical axis and an image-side surface being concave near the optical axis, at least one of the object-side surface and the image-side surface of the first lens element being aspheric; a stop; a second lens element with a positive refractive power having an image-side surface being convex near the optical axis, at least one of an object-side surface and the image-side surface of the second lens element being aspheric; and a third lens element with a refractive power having an object-side surface being convex near the optical axis and an image-side surface being concave near the optical axis, at least one of the object-side surface and the image-side surface of the third lens element being aspheric.

Preferably, a focal length of the three-piece infrared single wavelength lens system is f, a focal length of the first lens element and the second lens element combined is f12, and they satisfy the relation: 0.5<f/f12<1.1, so that the shortening of the total length of the system and the correction of aberration can be balanced.

Preferably, the focal length of the three-piece infrared single wavelength lens system is f, a focal length of the second lens element and the third lens element combined is f23, and they satisfy the relation: 0.8<f/f23<1.6, so that the shortening of the total length of the system and the correction of aberration can be balanced.

Preferably, a focal length of the first lens element is f1, a focal length of the second lens element is f2, and they satisfy the relation: −19<f1/f2<−1.4. Therefore, the refractive powers of the first and second lens elements can be properly distributed, so that the aberration of the three-piece infrared single wavelength lens system will not be too large.

Preferably, the focal length of the second lens element is f2, a focal length of the third lens element is f3, and they satisfy the relation: −0.02<f2/f3<0.26, so that the total optical length of the system can be reduced effectively.

Preferably, the focal length of the first lens element is f1, the focal length of the third lens element is f3, and they satisfy the relation: −1.5<f1/f3<0.07, it will be favorable to reduce the sensitivity and the aberration of the system.

Preferably, the focal length of the first lens element is f1, the focal length of the second lens element and the third lens element combined is f23, and they satisfy the relation: −23<f1/f23<−1.9, so that the resolution can be improved evidently.

Preferably, the focal length of the first lens element and the second lens element combined is f12, the focal length of the third lens element is f3, and they satisfy the relation: −0.05<f12/f3<0.37, so that the resolution can be improved evidently.

Preferably, a radius of curvature of the image-side surface of the first lens element is R1, a radius of curvature of the image source-side surface of the first lens element is R2, and they satisfy the relation: 0.9<R1/R2<5.3, which can provide good field of view and reduce the high order aberrations of the system.

Preferably, a radius of curvature of the image-side surface of the second lens element is R3, a radius of curvature of the image source-side surface of the second lens element is R4, and they satisfy the relation: −27<R3/R4<27, so that the astigmatism of the three-piece infrared single wavelength lens system can be reduced.

Preferably, a radius of curvature of the image-side surface of the third lens element is R5, a radius of curvature of the image source-side surface of the third lens element is R6, and they satisfy the relation: 0.7<R5/R6<1.5, so that the curvature configuration of the surfaces of the third lens element can be balanced effectively, so as to balance the field of view with the total track length.

Preferably, a central thickness of the first lens element along the optical axis is CT1, a central thickness of the second lens element along the optical axis is CT2, and they satisfy the relation: 0.5<CT1/CT2<1.1, so that the thicknesses of the first and second lens elements are more suitable, it is favorable to the homogeneity and formation of lens elements in manufacture.

Preferably, the central thickness of the second lens element along the optical axis is CT2, a central thickness of the third lens element along the optical axis is CT3, and they satisfy the relation: 0.9<CT2/CT3<2.4, so that the thicknesses of the second and third lens elements are more suitable, it is favorable to the homogeneity and formation of lens elements in manufacture.

Preferably, the central thickness of the first lens element along the optical axis is CT1, the central thickness of the third lens element along the optical axis is CT3, and they satisfy the relation: 0.6<CT1/CT3<1.8, so that the thicknesses of the first and third lens elements are more suitable, it is favorable to the homogeneity and formation of lens elements in manufacture.

Preferably, the focal length of the three-piece infrared single wavelength lens system is f, a distance from the image-side surface of the first lens element to the image source-side surface along the optical axis is TL, and they satisfy the relation: 0.3<f/TL<0.6, it will be favorable to maintain the objective of miniaturization and long focus of the three-piece infrared single wavelength lens system, which can be used in thin electronic products.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows a three-piece infrared single wavelength lens system in accordance with a first embodiment of the present invention;

FIG. 1B shows the image plane curve and the distortion curve of the first embodiment of the present invention;

FIG. 2A shows a three-piece infrared single wavelength lens system in accordance with a second embodiment of the present invention;

FIG. 2B shows the image plane curve and the distortion curve of the second embodiment of the present invention;

FIG. 3A shows a three-piece infrared single wavelength lens system in accordance with a third embodiment of the present invention;

FIG. 3B shows the image plane curve and the distortion curve of the third embodiment of the present invention;

FIG. 4A shows a three-piece infrared single wavelength lens system in accordance with a fourth embodiment of the present invention;

FIG. 4B shows the image plane curve and the distortion curve of the fourth embodiment of the present invention;

FIG. 5A shows a three-piece infrared single wavelength lens system in accordance with a fifth embodiment of the present invention;

FIG. 5B shows the image plane curve and the distortion curve of the fifth embodiment of the present invention;

FIG. 6A shows a three-piece infrared single wavelength lens system in accordance with a sixth embodiment of the present invention;

FIG. 6B shows the image plane curve and the distortion curve of the sixth embodiment of the present invention;

FIG. 7A shows a three-piece infrared single wavelength lens system in accordance with a seventh embodiment of the present invention; and

FIG. 7B shows the image plane curve and the distortion curve of the seventh embodiment of the present invention.

### DETAILED DESCRIPTION

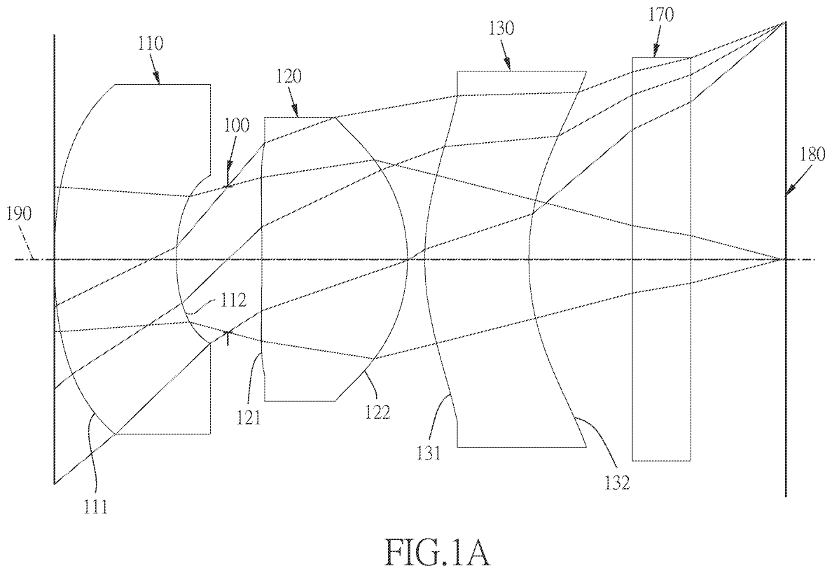

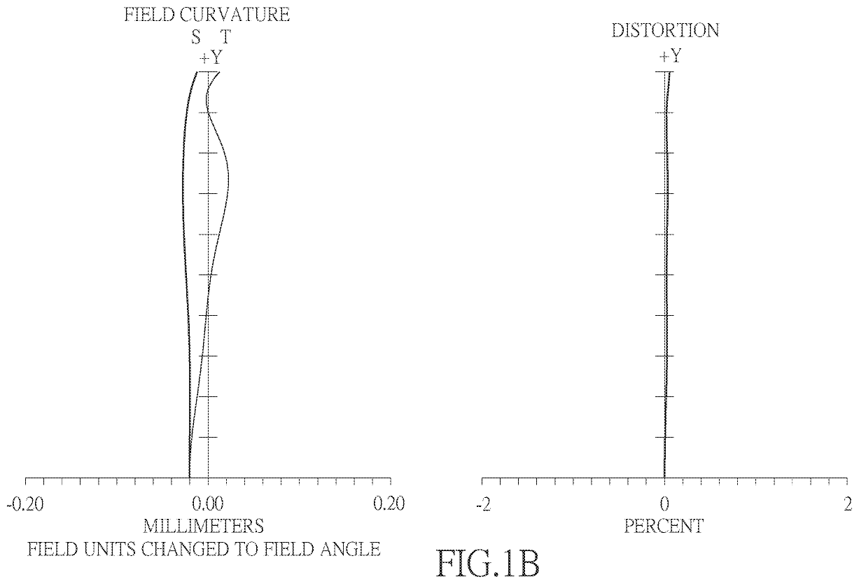

Referring to FIGS. 1A and 1B, FIG. 1A shows a three-piece infrared single wavelength lens system in accordance with a first embodiment of the present invention, and FIG. 1B shows, in order from left to right, the image plane curve and the distortion curve of the first embodiment of the present invention. A three-piece infrared single wavelength lens system in accordance with the first embodiment of the present invention comprises a stop 100 and a lens group. The lens group comprises, in order from an object side to an image side: a first lens element 110, a second lens element 120, a third lens element 130, an IR cut filter 170, and an image plane 180, wherein the three-piece infrared single wavelength lens system has a total of three lens elements with refractive power. The stop 100 is disposed between the first lens element 110 and the second lens element 120.

The first lens element 110 with a negative refractive power has an object-side surface 111 being convex near an optical axis 190 and an image-side surface 112 being concave near the optical axis 190, the object-side surface 111 and the image-side surface 112 are aspheric, and the first lens element 110 is made of plastic material.

The second lens element 120 with a positive refractive power has an object-side surface 121 being concave near the optical axis 190 and an image-side surface 122 being convex near the optical axis 190, the object-side surface 121 and the image-side surface 122 are aspheric, and the second lens element 120 is made of plastic material.

The third lens element 130 with a positive refractive power has an object-side surface 131 being convex near the optical axis 190 and an image-side surface 132 being concave near the optical axis 190, the object-side surface 131 and the image-side surface 132 are aspheric, the third lens element 130 is made of plastic material, and at least one of the object-side surface 131 and the image-side surface 132 is provided with at least one inflection point.

The IR cut filter 170 made of glass is located between the third lens element 130 and the image plane 180 and has no influence on the focal length of the three-piece infrared single wavelength lens system.

The equation for the aspheric surface profiles of the respective lens elements of the first embodiment is expressed as follows:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Fh}^{14} + {Gh}^{16} …$$

wherein:

z represents the value of a reference position with respect to a vertex of the surface of a lens and a position with a height h along the optical axis 190;

c represents a paraxial curvature equal to 1/R (R: a paraxial radius of curvature);

h represents a vertical distance from the point on the curve of the aspheric surface to the optical axis 190;

k represents the conic constant;

A, B, C, D, E, F, G, . . . : represent the high-order aspheric coefficients.

In the first embodiment of the present three-piece infrared single wavelength lens system, a focal length of the three-piece infrared single wavelength lens system is f, a f-number of the three-piece infrared single wavelength lens system is Fno, the three-piece infrared single wavelength lens system has a maximum view angle (field of view) FOV, and they satisfy the relations: f=1.46 mm; Fno=2.0; and FOV=77.99 degrees.

In the first embodiment of the present three-piece infrared single wavelength lens system, the focal length of the three-piece infrared single wavelength lens system is f, a focal length of the first lens element 110 and the second lens element 120 combined is f12, and they satisfy the relation: f/f12=0.76.

In the first embodiment of the present three-piece infrared single wavelength lens system, the focal length of the three-piece infrared single wavelength lens system is f, a focal length of the second lens element 120 and the third lens element 130 combined is f23, and they satisfy the relation: f/f23=1.29.

In the first embodiment of the present three-piece infrared single wavelength lens system, a focal length of the first lens element 110 is f1, a focal length of the second lens element 120 is f2, and they satisfy the relation: f1/f2=−2.18.

In the first embodiment of the present three-piece infrared single wavelength lens system, the focal length of the second lens element 120 is f2, a focal length of the third lens element 130 is f3, and they satisfy the relation: f2/f3=0.11.

In the first embodiment of the present three-piece infrared single wavelength lens system, the focal length of the first lens element 110 is f1, the focal length of the third lens element 130 is f3, and they satisfy the relation: f1/f3=−0.23. In the first embodiment of the present three-piece infrared single wavelength lens system, the focal length of the first lens element 110 is f1, the focal length of the second lens element 120 and the third lens element 130 combined is f23, and they satisfy the relation: f1/f23=−2.73.

In the first embodiment of the present three-piece infrared single wavelength lens system, the focal length of the first lens element 110 and the second lens element 120 combined is f12, the focal length of the third lens element 130 is f3, and they satisfy the relation: f12/f3=0.14.

In the first embodiment of the present three-piece infrared single wavelength lens system, the focal length of the three-piece infrared single wavelength lens system is f, a distance from the object-side surface 111 of the first lens element 110 to the image plane 180 along the optical axis 190 is TL, and they satisfy the relation: f/TL=0.39.

In the first embodiment of the present three-piece infrared single wavelength lens system, a radius of curvature of the image-side surface 111 of the first lens element 110 is R1, a radius of curvature of the image source-side surface 112 of the first lens element 110 is R2, and they satisfy the relation: R1/R2=2.53.

In the first embodiment of the present three-piece infrared single wavelength lens system, a radius of curvature of the image-side surface 121 of the second lens element 120 is R3, a radius of curvature of the image source-side surface 122 of the second lens element 120 is R4, and they satisfy the relation: R3/R4=21.37.

In the first embodiment of the present three-piece infrared single wavelength lens system, a radius of curvature of the image-side surface 131 of the third lens element 130 is R5, a radius of curvature of the image source-side surface 132 of the third lens element 130 is R6, and they satisfy the relation: R5/R6=0.99.

In the first embodiment of the present three-piece infrared single wavelength lens system, a central thickness of the first lens element 110 along the optical axis 190 is CT1, a central thickness of the second lens element 120 along the optical axis 190 is CT2, and they satisfy the relation: CT1/CT2=0.84.

In the first embodiment of the present three-piece infrared single wavelength lens system, the central thickness of the second lens element 120 along the optical axis 190 is CT2, a central thickness of the third lens element 130 along the optical axis 190 is CT3, and they satisfy the relation: CT2/CT3=1.40.

In the first embodiment of the present three-piece infrared single wavelength lens system, the central thickness of the first lens element 110 along the optical axis 190 is CT1, the central thickness of the third lens element 130 along the optical axis 190 is CT3, and they satisfy the relation: CT1/CT3=1.17.

The detailed optical data of the first embodiment is shown in table 1, and the aspheric surface data is shown in table 2.

TABLE 1
Embodiment 1
f(focal length) = 1.46 mm, Fno = 2.0, FOV = 77.99 deg.

| | | Curvature | | | | | | Focal |
|---|---|---|---|---|---|---|---|---|
| surface | | Radius | | Thickness | Material | Index | Abbe # | length |
| 0 | object | infinity | | 400 | | | | |
| 1 | | infinity | | 0 | | | | |
| 2 | Lens 1 | 2.471 | (ASP) | 0.627 | plastic | 1.64 | 22.46 | −3.10 |
| 3 | | 0.977 | (ASP) | 0.265 | | | | |
| 4 | stop | infinity | | 0.175 | | | | |
| 5 | Lens 2 | −18.292 | (ASP) | 0.748 | plastic | 1.64 | 22.46 | 1.42 |
| 6 | | −0.856 | (ASP) | 0.089 | | | | |
| 7 | Lens 3 | 1.347 | (ASP) | 0.535 | plastic | 1.64 | 22.46 | 13.54 |
| 8 | | 1.360 | (ASP) | 0.532 | | | | |
| 9 | IR-filter | infinity | | 0.300 | glass | 1.517 | 64.17 | |
| 10 | | infinity | | 0.487 | | | | |
| 11 | Image | infinity | | — | | | | |
| | plane | | | | | | | |

[symbol]

2
Aspheric Coefficients

| surface | 2 | 3 | 5 | 6 | 7 | 8 |
|---|---|---|---|---|---|---|
| K: | −1.0327E+01 | 3.0863E+00 | 1.0000E+02 | −5.8755E+00 | −3.1425E+00 | 5.0181E−01 |
| A: | 3.1022E−01 | 9.6810E−01 | 1.2756E−02 | −1.3466E+00 | −6.3764E−02 | 1.9540E−01 |
| B: | −3.1197E−02 | −1.5244E+00 | 1.1466E+00 | 2.6519E+00 | −2.3095E−01 | −9.8564E−01 |
| C: | −7.6936E−01 | 1.5958E+01 | −1.3834E+01 | −5.7362E+00 | 7.8978E−01 | 1.4447E+00 |
| D: | 3.6174E+00 | 7.9098E+00 | 9.0565E+01 | 7.7256E+00 | −8.0977E−01 | −1.2454E+00 |
| E: | −7.0575E+00 | 2.7563E+02 | −2.6962E+02 | 1.7481E+00 | −2.0375E+00 | 2.2039E−02 |
| F | 6.7217E+00 | −4.2786E+03 | 4.0275E+02 | −2.6779E+01 | 5.0798E+00 | 8.3253E−01 |
| G | −2.4889E+00 | 2.1456E+04 | −2.5241E+02 | 3.3857E+01 | −2.9953E+00 | −4.7259E−01 |

The units of the radius of curvature, the thickness and the focal length in table 1 are expressed in mm, the surface numbers 0-11 represent the surfaces sequentially arranged from the object-side to the image-side along the optical axis. In table 2, k represents the conic coefficient of the equation of the aspheric surface profiles, and A, B, C, D, E, F, G . . . : represent the high-order aspheric coefficients. The tables presented below for each embodiment are the corresponding schematic parameter, image plane curves and distortion curves, and the definitions of the tables are the same as Table 1 and Table 2 of the first embodiment. Therefore, an explanation in this regard will not be provided again.

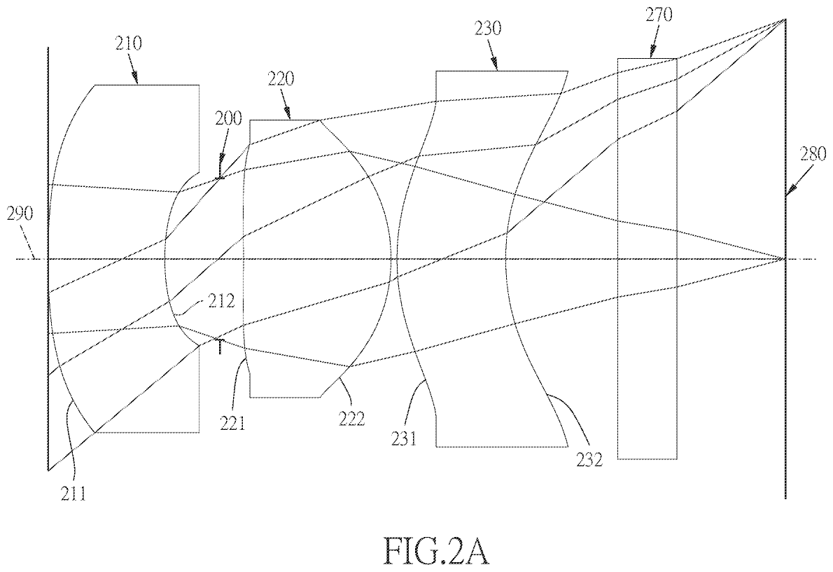

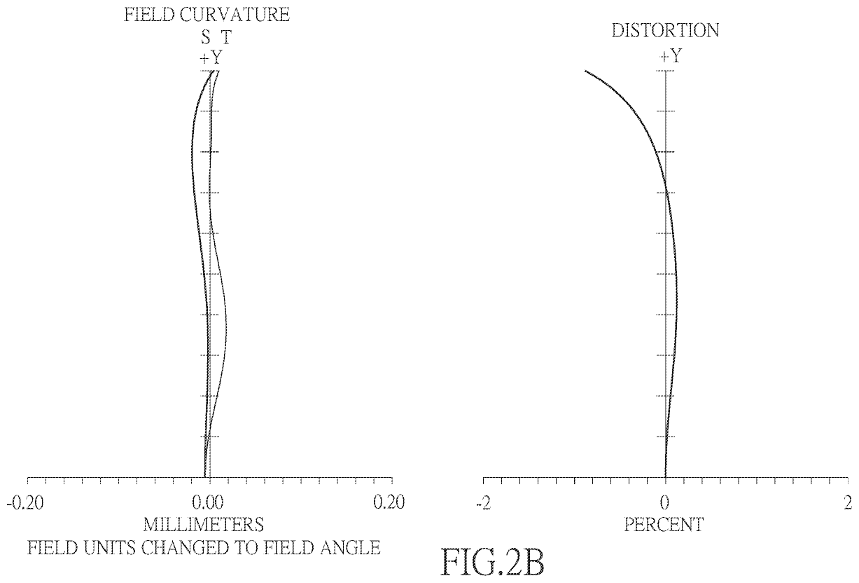

Referring to FIGS. 2A and 2B, FIG. 2A shows a three-piece infrared single wavelength lens system in accordance with a second embodiment of the present invention, and FIG. 2B shows, in order from left to right, the image plane curve and the distortion curve of the second embodiment of the present invention. A three-piece infrared single wavelength lens system in accordance with the second embodiment of the present invention comprises a stop 200 and a lens group. The lens group comprises, in order from an object side to an image side: a first lens element 210, a second lens element 220, a third lens element 230, an IR cut filter 270, and an image plane 280, wherein the three-piece infrared single wavelength lens system has a total of three lens elements with refractive power. The stop 200 is disposed between the first lens element 210 and the second lens element 220.

The first lens element 210 with a negative refractive power has an object-side surface 211 being convex near an optical axis 290 and an image-side surface 212 being concave near the optical axis 290, the object-side surface 211 and the image-side surface 212 are aspheric, and the first lens element 210 is made of plastic material.

The second lens element 220 with a positive refractive power has an object-side surface 221 being concave near the optical axis 290 and an image-side surface 222 being convex near the optical axis 290, the object-side surface 221 and the image-side surface 222 are aspheric, and the second lens element 220 is made of plastic material.

The third lens element 230 with a positive refractive power has an object-side surface 231 being convex near the optical axis 290 and an image-side surface 232 being concave near the optical axis 290, the object-side surface 231 and the image-side surface 232 are aspheric, the third lens element 230 is made of plastic material, and at least one of the object-side surface 231 and the image-side surface 232 is provided with at least one inflection point.

The IR cut filter 270 made of glass is located between the third lens element 230 and the image plane 280 and has no influence on the focal length of the three-piece infrared single wavelength lens system.

The detailed optical data of the second embodiment is shown in table 3, and the aspheric surface data is shown in table 4.

TABLE 3
Embodiment 2
f(focal length) = 1.49 mm, Fno = 2.0, FOV = 77.91 deg.

| | | Curvature | | | | | | Focal |
|---|---|---|---|---|---|---|---|---|
| surface | | Radius | | Thickness | Material | Index | Abbe # | length |
| 0 | object | infinity | | 400 | | | | |
| 1 | | infinity | | 0 | | | | |
| 2 | Lens 1 | 3.812 | (ASP) | 0.594 | plastic | 1.64 | 22.46 | −2.79 |
| 3 | | 1.116 | (ASP) | 0.280 | | | | |
| 4 | stop | infinity | | 0.121 | | | | |
| 5 | Lens 2 | −14.118 | (ASP) | 0.751 | plastic | 1.54 | 56 | 1.59 |
| 6 | | −0.815 | (ASP) | 0.030 | | | | |
| 7 | Lens 3 | 1.079 | (ASP) | 0.554 | plastic | 1.54 | 56 | 7.89 |
| 8 | | 1.191 | (ASP) | 0.571 | | | | |

| | | | | | | |
|---|---|---|---|---|---|---|
| 9 | IR-filter | infinity | 0.300 | glass | 1.517 | 64.17 |
| 10 | | infinity | 0.554 | | | |
| 11 | Image | infinity | — | | | |
| | plane | | | | | |

TABLE 4
Aspheric Coefficients

| surface | 2 | 3 | 5 | 6 | 7 | 8 |
|---|---|---|---|---|---|---|
| K: | 6.1294E−01 | 4.1054E+00 | −8.5037E+01 | −5.7819E+00 | −1.7078E+00 | 3.0868E−01 |
| A: | 2.9587E−01 | 9.8160E−01 | 2.8199E−01 | −1.4358E+00 | −5.0194E−02 | 3.3745E−01 |
| B: | −8.5807E−02 | 3.8457E−01 | 1.1145E+00 | 2.6237E+00 | −2.4864E−01 | −1.2885E+00 |
| C: | −7.7507E−01 | 1.0655E+01 | −1.4238E+01 | −5.4432E+00 | 5.7364E−01 | 1.4215E+00 |
| D: | 3.7345E+00 | 6.2729E+00 | 9.0630E+01 | 7.7065E+00 | −7.9521E−01 | −1.1033E+00 |
| E: | −7.1555E+00 | 4.3767E+02 | −2.7077E+02 | 3.2756E−01 | −1.8521E+00 | −3.2038E−02 |
| F | 6.5121E+00 | −4.6057E+03 | 3.9975E+02 | −2.8291E+01 | 4.9918E+00 | 8.4759E−01 |
| G | −2.3272E+00 | 1.7582E+04 | −2.4111E+02 | 4.3738E+01 | −3.1894E+00 | −5.1100E−01 |

In the second embodiment, the equation of the aspheric surface profiles of the aforementioned lens elements is the same as the equation of the first embodiment. Also, the definitions of these parameters shown in the following table are the same as those stated in the first embodiment with corresponding values for the second embodiment, so an explanation in this regard will not be provided again.

Moreover, these parameters can be calculated from Table 3 and Table 4 as the following values and satisfy the following conditions:

Embodiment 2

| | | | |
|---|---|---|---|
| f[mm] | 1.49 | f12/f3 | 0.29 |
| Fno | 2.0 | f/TL | 0.40 |
| FOV[deg.] | 77.91 | R1/R2 | 3.42 |
| f/f12 | 0.65 | R3/R4 | 17.33 |
| f/f23 | 1.28 | R5/R6 | 0.91 |
| f1/f2 | −1.76 | CT1/CT2 | 0.79 |
| f2/f3 | 0.20 | CT2/CT3 | 1.36 |
| f1/f3 | −0.35 | CT1/CT3 | 1.07 |
| f1/f23 | −2.40 | | |

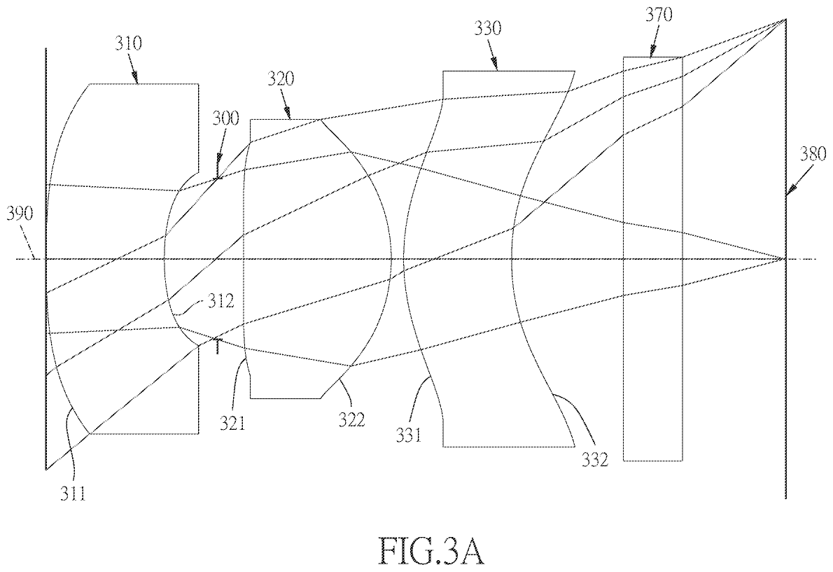

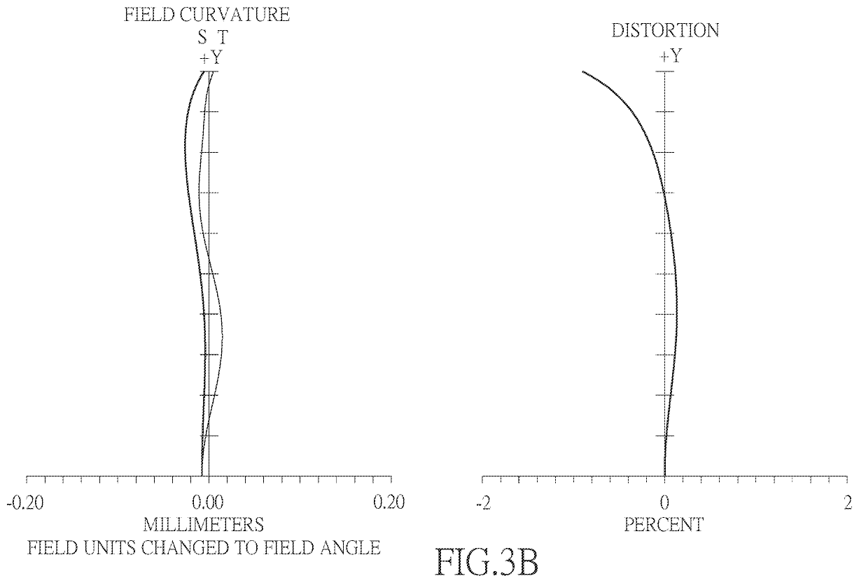

Referring to FIGS. 3A and 3B, FIG. 3A shows a three-piece infrared single wavelength lens system in accordance with a third embodiment of the present invention, and FIG. 3B shows, in order from left to right, the image plane curve and the distortion curve of the third embodiment of the present invention. A three-piece infrared single wavelength lens system in accordance with the third embodiment of the present invention comprises a stop 300 and a lens group. The lens group comprises, in order from an object side to an image side: a first lens element 310, a second lens element 320, a third lens element 330, an IR cut filter 370, and an image plane 380, wherein the three-piece infrared single wavelength lens system has a total of three lens elements with refractive power. The stop 300 is disposed between the first lens element 310 and the second lens element 320.

The first lens element 310 with a negative refractive power has an object-side surface 311 being convex near an optical axis 390 and an image-side surface 312 being concave near the optical axis 390, the object-side surface 311 and the image-side surface 312 are aspheric, and the first lens element 310 is made of plastic material.

The second lens element 320 with a positive refractive power has an object-side surface 321 being concave near the optical axis 390 and an image-side surface 322 being convex near the optical axis 390, the object-side surface 321 and the image-side surface 322 are aspheric, and the second lens element 320 is made of plastic material.

The third lens element 330 with a positive refractive power has an object-side surface 331 being convex near the optical axis 390 and an image-side surface 332 being concave near the optical axis 390, the object-side surface 331 and the image-side surface 332 are aspheric, the third lens element 330 is made of plastic material, and at least one of the object-side surface 331 and the image-side surface 332 is provided with at least one inflection point.

The IR cut filter 370 made of glass is located between the third lens element 330 and the image plane 380 and has no influence on the focal length of the three-piece infrared single wavelength lens system.

The detailed optical data of the third embodiment is shown in table 5, and the aspheric surface data is shown in table 6.

TABLE 5
Embodiment 3
f(focal length) = 1.49 mm, Fno = 2.0, FOV = 77.90 deg.

| | | Curvature | | | | | | Focal |
|---|---|---|---|---|---|---|---|---|
| surface | | Radius | | Thickness | Material | Index | Abbe # | length |
| 0 | object | infinity | | 400 | | | | |
| 1 | | infinity | | 0 | | | | |
| 2 | Lens 1 | 4.705 | (ASP) | 0.602 | plastic | 1.54 | 56 | −2.98 |
| 3 | | 1.137 | (ASP) | 0.271 | | | | |
| 4 | stop | infinity | | 0.133 | | | | |
| 5 | Lens 2 | −16.856 | (ASP) | 0.750 | plastic | 1.54 | 56 | 1.59 |
| 6 | | −0.822 | (ASP) | 0.063 | | | | |
| 7 | Lens 3 | 1.087 | (ASP) | 0.549 | plastic | 1.54 | 56 | 8.86 |
| 8 | | 1.162 | (ASP) | 0.570 | | | | |

| | | | | | | |
|---|---|---|---|---|---|---|
| 9 | IR-filter | infinity | 0.300 | glass | 1.517 | 64.17 |
| 10 | | infinity | 0.525 | | | |
| 11 | Image | infinity | — | | | |
| | plane | | | | | |

TABLE 6
Aspheric Coefficients

| surface | 2 | 3 | 5 | 6 | 7 | 8 |
|---|---|---|---|---|---|---|
| K: | 3.8604E+00 | 3.2101E+00 | −1.0001E+02 | −6.1038E+00 | −1.5996E+00 | 2.6418E−01 |
| A: | 3.0709E−01 | 1.0878E+00 | 2.0179E−01 | −1.4445E+00 | −6.1041E−02 | 2.9361E−01 |
| B: | −1.1443E−01 | 9.3265E−01 | 1.2597E+00 | 2.6941E+00 | −2.9449E−01 | −1.2264E+00 |
| C: | −7.5850E−01 | 1.5572E+01 | −1.3966E+01 | −5.5142E+00 | 6.8511E−01 | 1.3989E+00 |
| D: | 3.7253E+00 | −2.1114E+01 | 9.0065E+01 | 7.5212E+00 | −7.4286E−01 | −1.1461E+00 |
| E: | −7.1213E+00 | 3.5686E+02 | −2.7158E+02 | 7.7397E−01 | −2.0586E+00 | −2.2590E−02 |
| F | 6.4293E+00 | −3.5542E+03 | 3.9946E+02 | −2.7494E+01 | 4.9270E+00 | 9.4774E−01 |
| G | −2.2747E+00 | 1.6967E+04 | −2.3662E+02 | 4.1759E+01 | −2.9126E+00 | −5.9429E−01 |

In the third embodiment, the equation of the aspheric surface profiles of the aforementioned lens elements is the same as the equation of the first embodiment. Also, the definitions of these parameters shown in the following table are the same as those stated in the first embodiment with corresponding values for the third embodiment, so an explanation in this regard will not be provided again.

Moreover, these parameters can be calculated from Table 5 and Table 6 as the following values and satisfy the following conditions:

Embodiment 3

| | | | |
|---|---|---|---|
| f[mm] | 1.49 | f12/f3 | 0.25 |
| Fno | 2.0 | f/TL | 0.40 |
| FOV[deg.] | 77.90 | R1/R2 | 4.14 |
| f/f12 | 0.68 | R3/R4 | 20.50 |
| f/f23 | 1.25 | R5/R6 | 0.94 |
| f1/f2 | −1.87 | CT1/CT2 | 0.80 |
| f2/f3 | 0.18 | CT2/CT3 | 1.37 |
| f1/f3 | −0.34 | CT1/CT3 | 1.10 |
| f1/f23 | −2.51 | | |

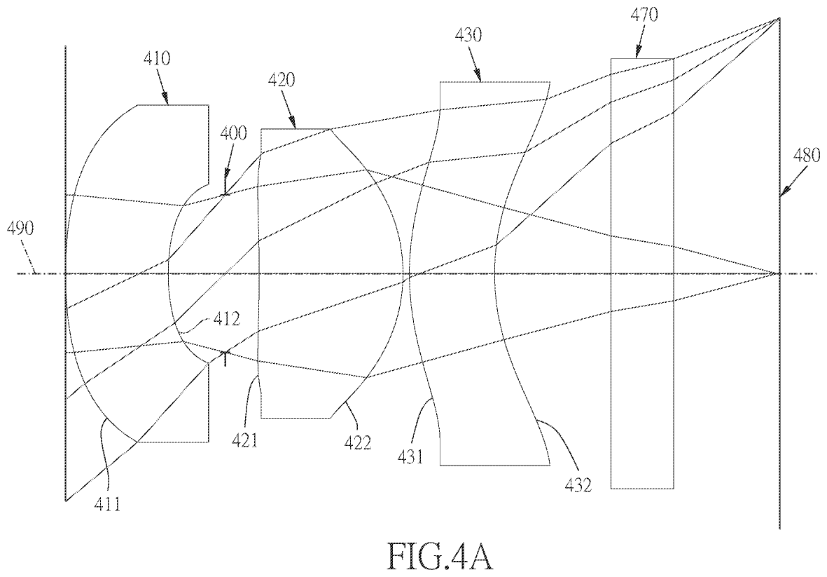

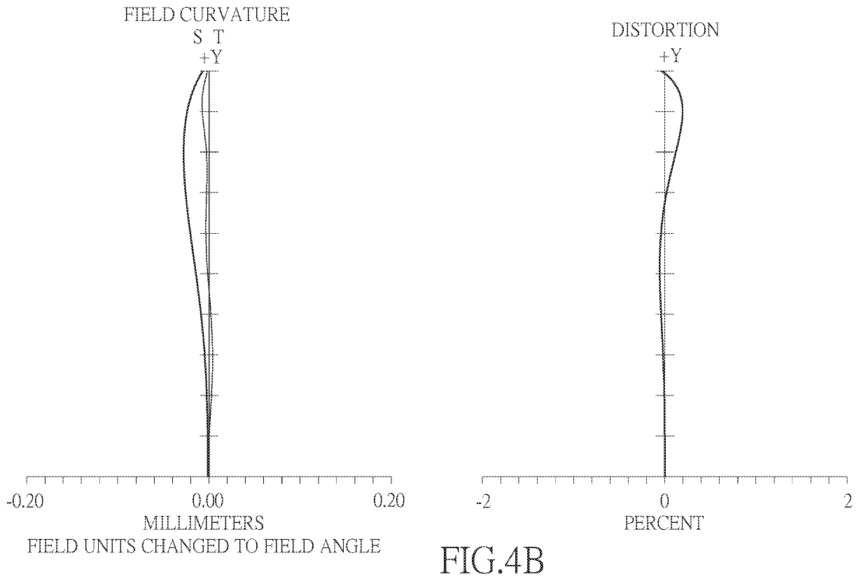

Referring to FIGS. 4A and 4B, FIG. 4A shows a three-piece infrared single wavelength lens system in accordance with a fourth embodiment of the present invention, and FIG. 4B shows, in order from left to right, the image plane curve and the distortion curve of the fourth embodiment of the present invention. A three-piece infrared single wavelength lens system in accordance with the fourth embodiment of the present invention comprises a stop 400 and a lens group. The lens group comprises, in order from an object side to an image side: a first lens element 410, a second lens element 420, a third lens element 430, an IR cut filter 470, and an image plane 480, wherein the three-piece infrared single wavelength lens system has a total of three lens elements with refractive power. The stop 400 is disposed between the first lens element 410 and the second lens element 420.

The first lens element 410 with a negative refractive power has an object-side surface 411 being convex near an optical axis 490 and an image-side surface 412 being concave near the optical axis 490, the object-side surface 411 and the image-side surface 412 are aspheric, and the first lens element 410 is made of plastic material.

The second lens element 420 with a positive refractive power has an object-side surface 421 being concave near the optical axis 490 and an image-side surface 422 being convex near the optical axis 490, the object-side surface 421 and the image-side surface 422 are aspheric, and the second lens element 420 is made of plastic material.

The third lens element 430 with a negative refractive power has an object-side surface 431 being convex near the optical axis 490 and an image-side surface 432 being concave near the optical axis 490, the object-side surface 431 and the image-side surface 432 are aspheric, the third lens element 430 is made of plastic material, and at least one of the object-side surface 431 and the image-side surface 432 is provided with at least one inflection point.

The IR cut filter 470 made of glass is located between the third lens element 430 and the image plane 480 and has no influence on the focal length of the three-piece infrared single wavelength lens system.

The detailed optical data of the fourth embodiment is shown in table 7, and the aspheric surface data is shown in table 8.

TABLE 7
Embodiment 4
f(focal length) = 1.48 mm, Fno = 2.0, FOV = 77.92 deg.

| | | Curvature | | | | | | Focal |
|---|---|---|---|---|---|---|---|---|
| surface | | Radius | | Thickness | Material | Index | Abbe # | length |
| 0 | object | infinity | | 400 | | | | |
| 1 | | infinity | | 0 | | | | |
| 2 | Lens 1 | 1.956 | (ASP) | 0.491 | plastic | 1.64 | 22.46 | −3.90 |
| 3 | | 0.977 | (ASP) | 0.272 | | | | |
| 4 | stop | infinity | | 0.162 | | | | |
| 5 | Lens 2 | −7.733 | (ASP) | 0.688 | plastic | 1.64 | 22.46 | 1.31 |
| 6 | | −0.763 | (ASP) | 0.031 | | | | |
| 7 | Lens 3 | 1.269 | (ASP) | 0.407 | plastic | 1.64 | 22.46 | −78.93 |
| 8 | | 1.085 | (ASP) | 0.556 | | | | |
| 9 | IR-filter | infinity | | 0.300 | glass | 1.517 | 64.17 | |
| 10 | | infinity | | 0.506 | | | | |
| 11 | Image | infinity | | — | | | | |
| | plane | | | | | | | |

TABLE 8
Aspheric Coefficients

| surface | 2 | 3 | 5 | 6 | 7 | 8 |
|---|---|---|---|---|---|---|
| K: | −2.2390E+00 | 4.1672E+00 | 7.2309E+01 | −4.7502E+00 | −1.9112E+00 | 1.4270E−01 |
| A: | 3.5786E−01 | 7.9903E−01 | 5.1762E−02 | −1.3765E+00 | −7.1093E−02 | 8.8149E−02 |
| B: | 5.5728E−02 | 1.2861E+00 | 1.5493E+00 | 2.7087E+00 | −3.5407E−01 | −1.1246E+00 |
| C: | −5.7846E−01 | 3.3499E+00 | −1.3171E+01 | −5.7142E+00 | 6.9128E−01 | 1.4349E+00 |
| D: | 3.6046E+00 | 4.7493E+00 | 8.8838E+01 | 7.4603E+00 | −8.1157E−01 | −1.1405E+00 |
| E: | −7.2812E+00 | 3.9678E+02 | −2.7472E+02 | 1.1838E+00 | −1.7842E+00 | 1.6324E−02 |
| F | 6.6380E+00 | −4.4874E+03 | 4.0815E+02 | −2.5526E+01 | 5.4012E+00 | 6.2446E−01 |
| G | −1.3242E+00 | 2.3249E+04 | −2.4394E+02 | 4.2597E+01 | −3.9130E+00 | −3.9325E−01 |

In the fourth embodiment, the equation of the aspheric surface profiles of the aforementioned lens elements is the same as the equation of the first embodiment. Also, the definitions of these parameters shown in the following table are the same as those stated in the first embodiment with corresponding values for the fourth embodiment, so an explanation in this regard will not be provided again.

Moreover, these parameters can be calculated from Table 7 and Table 8 as the following values and satisfy the following conditions:

Embodiment 4

| | | | |
|---|---|---|---|
| f[mm] | 1.48 | f12/f3 | −0.02 |
| Fno | 2.0 | f/TL | 0.43 |
| FOV[deg.] | 77.92 | R1/R2 | 2.00 |
| f/f12 | 0.89 | R3/R4 | 10.14 |
| f/f23 | 1.27 | R5/R6 | 1.17 |
| f1/f2 | −2.97 | CT1/CT2 | 0.71 |
| f2/f3 | −0.02 | CT2/CT3 | 1.69 |
| f1/f3 | 0.05 | CT1/CT3 | 1.21 |
| f1/f23 | −3.34 | | |

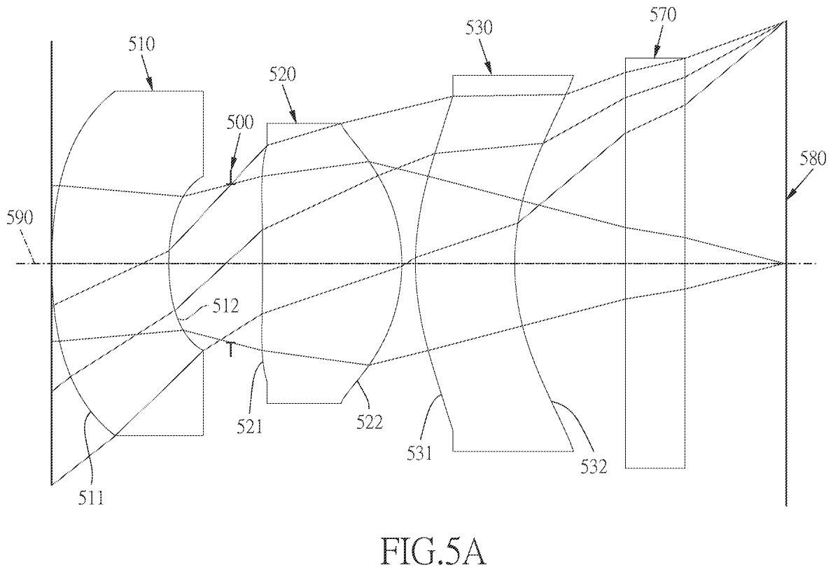

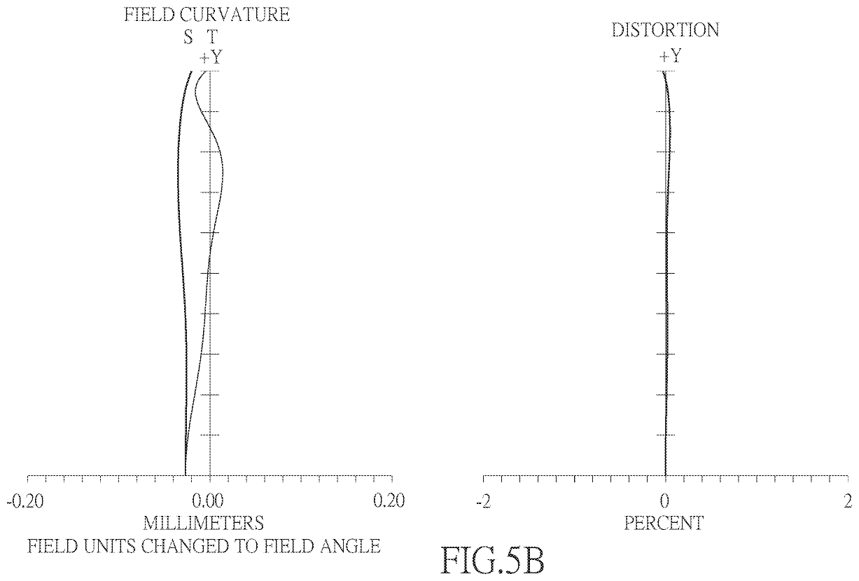

Referring to FIGS. 5A and 5B, FIG. 5A shows a three-piece infrared single wavelength lens system in accordance with a fifth embodiment of the present invention, and FIG. 5B shows, in order from left to right, the image plane curve and the distortion curve of the fifth embodiment of the present invention. A three-piece infrared single wavelength lens system in accordance with the fifth embodiment of the present invention comprises a stop 500 and a lens group. The lens group comprises, in order from an object side to an image side: a first lens element 510, a second lens element 520, a third lens element 530, an IR cut filter 570, and an image plane 580, wherein the three-piece infrared single wavelength lens system has a total of three lens elements with refractive power. The stop 500 is disposed between the first lens element 510 and the second lens element 520.

The first lens element 510 with a negative refractive power has an object-side surface 511 being convex near an optical axis 590 and an image-side surface 512 being concave near the optical axis 590, the object-side surface 511 and the image-side surface 512 are aspheric, and the first lens element 510 is made of plastic material.

The second lens element 520 with a positive refractive power has an object-side surface 521 being concave near the optical axis 590 and an image-side surface 522 being convex near the optical axis 590, the object-side surface 521 and the image-side surface 522 are aspheric, and the second lens element 520 is made of plastic material.

The third lens element 530 with a positive refractive power has an object-side surface 531 being convex near the optical axis 590 and an image-side surface 532 being concave near the optical axis 590, the object-side surface 531 and the image-side surface 532 are aspheric, the third lens element 530 is made of plastic material, and at least one of the object-side surface 531 and the image-side surface 532 is provided with at least one inflection point.

The IR cut filter 570 made of glass is located between the third lens element 530 and the image plane 580 and has no influence on the focal length of the three-piece infrared single wavelength lens system.

The detailed optical data of the fifth embodiment is shown in table 9, and the aspheric surface data is shown in table 10.

TABLE 9
Embodiment 5
f(focal length) = 1.54 mm, Fno = 2.0, FOV = 74.94 deg.

| | | Curvature | | | | | | Focal |
|---|---|---|---|---|---|---|---|---|
| surface | | Radius | | Thickness | Material | Index | Abbe # | length |
| 0 | object | infinity | | 400 | | | | |
| 1 | | infinity | | 0 | | | | |
| 2 | Lens 1 | 2.202 | (ASP) | 0.590 | plastic | 1.64 | 22.46 | −3.90 |
| 3 | | 1.035 | (ASP) | 0.313 | | | | |
| 4 | stop | infinity | | 0.160 | | | | |
| 5 | Lens 2 | −10.566 | (ASP) | 0.701 | plastic | 1.64 | 22.46 | 1.49 |
| 6 | | −0.869 | (ASP) | 0.068 | | | | |
| 7 | Lens 3 | 1.322 | (ASP) | 0.501 | plastic | 1.64 | 22.46 | 17.49 |
| 8 | | 1.287 | (ASP) | 0.557 | | | | |

| | | | | | | |
|---|---|---|---|---|---|---|
| 9 | IR-filter | infinity | 0.300 | glass | 1.517 | 64.17 |
| 10 | | infinity | 0.512 | | | |
| 11 | Image | infinity | — | | | |
| | plane | | | | | |

TABLE 10
Aspheric Coefficients

| surface | 2 | 3 | 5 | 6 | 7 | 8 |
|---|---|---|---|---|---|---|
| K: | −7.8009E+00 | 4.0019E+00 | 8.2382E+01 | −6.3430E+00 | −2.5821E+00 | 3.6935E−01 |
| A: | 3.2392E−01 | 9.2476E−01 | 4.3206E−02 | −1.3338E+00 | −5.4925E−02 | 1.7484E−01 |
| B: | −4.7520E−03 | −2.2725E+00 | 1.5276E+00 | 2.7900E+00 | −2.3750E−01 | −1.0033E+00 |
| C: | −7.4350E−01 | 1.6052E+01 | −1.3402E+01 | −5.6303E+00 | 7.9650E−01 | 1.4545E+00 |
| D: | 3.6126E+00 | 2.0368E+01 | 8.9465E+01 | 7.5649E+00 | −7.8032E−01 | −1.2230E+00 |
| E: | −7.0746E+00 | 2.4563E+02 | −2.7315E+02 | 1.5984E+00 | −2.0042E+00 | 3.1563E−02 |
| F | 6.7177E+00 | −4.8788E+03 | 4.0098E+02 | −2.5663E+01 | 5.1399E+00 | 8.3926E−01 |
| G | −2.4136E+00 | 1.9148E+04 | −2.3677E+02 | 3.8274E+01 | −3.1164E+00 | −5.2049E−01 |

In the fifth embodiment, the equation of the aspheric surface profiles of the aforementioned lens elements is the same as the equation of the first embodiment. Also, the definitions of these parameters shown in the following table are the same as those stated in the first embodiment with corresponding values for the fifth embodiment, so an explanation in this regard will not be provided again.

Moreover, these parameters can be calculated from Table 9 and Table 10 as the following values and satisfy the following conditions:

Embodiment 5

| | | | |
|---|---|---|---|
| f[mm] | 1.54 | f12/f3 | 0.11 |
| Fno | 2.0 | f/TL | 0.42 |
| FOV[deg.] | 74.94 | R1/R2 | 2.13 |
| f/f12 | 0.78 | R3/R4 | 12.15 |
| f/f23 | 1.28 | R5/R6 | 1.03 |
| f1/f2 | −2.63 | CT1/CT2 | 0.84 |
| f2/f3 | 0.08 | CT2/CT3 | 1.40 |
| f1/f3 | −0.22 | CT1/CT3 | 1.18 |
| f1/f23 | −3.24 | | |

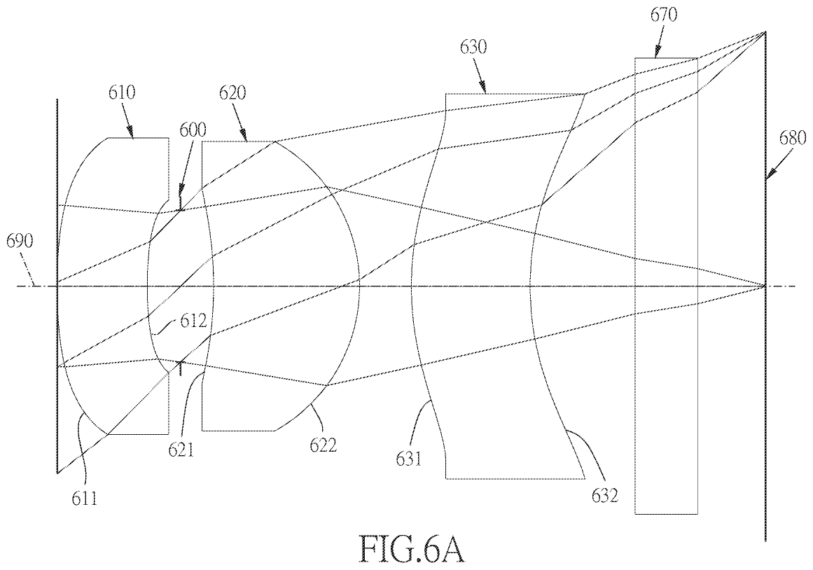

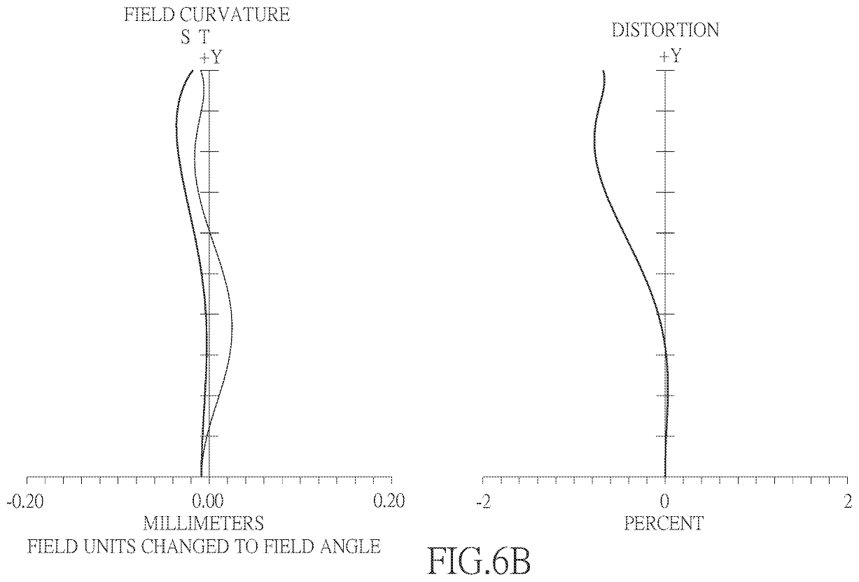

Referring to FIGS. 6A and 6B, FIG. 6A shows a three-piece infrared single wavelength lens system in accordance with a sixth embodiment of the present invention, and FIG. 6B shows, in order from left to right, the image plane curve and the distortion curve of the sixth embodiment of the present invention. A three-piece infrared single wavelength lens system in accordance with the sixth embodiment of the present invention comprises a stop 600 and a lens group. The lens group comprises, in order from an object side to an image side: a first lens element 610, a second lens element 620, a third lens element 630, an IR cut filter 670, and an image plane 680, wherein the three-piece infrared single wavelength lens system has a total of three lens elements with refractive power. The stop 600 is disposed between the first lens element 610 and the second lens element 620.

The first lens element 610 with a negative refractive power has an object-side surface 611 being convex near an optical axis 690 and an image-side surface 612 being concave near the optical axis 690, the object-side surface 611 and the image-side surface 612 are aspheric, and the first lens element 610 is made of plastic material.

The second lens element 620 with a positive refractive power has an object-side surface 621 being concave near the optical axis 690 and an image-side surface 622 being convex near the optical axis 690, the object-side surface 621 and the image-side surface 622 are aspheric, and the second lens element 620 is made of plastic material.

The third lens element 630 with a positive refractive power has an object-side surface 631 being convex near the optical axis 690 and an image-side surface 632 being concave near the optical axis 690, the object-side surface 631 and the image-side surface 632 are aspheric, the third lens element 630 is made of plastic material, and at least one of the object-side surface 631 and the image-side surface 632 is provided with at least one inflection point.

The IR cut filter 670 made of glass is located between the third lens element 630 and the image plane 680 and has no influence on the focal length of the three-piece infrared single wavelength lens system.

The detailed optical data of the sixth embodiment is shown in table 11, and the aspheric surface data is shown in table 12.

TABLE 11
Embodiment 6
f(focal length) = 1.57 mm, Fno = 2.1, FOV = 74.88 deg.

| | | Curvature | | | | | | Focal |
|---|---|---|---|---|---|---|---|---|
| surface | | Radius | | Thickness | Material | Index | Abbe # | length |
| 0 | object | infinity | | infinity | | | | |
| 1 | | infinity | | 0 | | | | |
| 2 | Lens 1 | 2.500 | (ASP) | 0.433 | plastic | 1.54 | 56 | −26.05 |
| 3 | | 1.988 | (ASP) | 0.159 | | | | |
| 4 | stop | infinity | | 0.160 | | | | |
| 5 | Lens 2 | −1.834 | (ASP) | 0.701 | plastic | 1.63 | 23.9 | 1.75 |
| 6 | | −0.775 | (ASP) | 0.249 | | | | |
| 7 | Lens 3 | 1.407 | (ASP) | 0.570 | plastic | 1.54 | 56 | 22.37 |
| 8 | | 1.375 | (ASP) | 0.503 | | | | |

| | | | | | | |
|---|---|---|---|---|---|---|
| 9 | IR-filter | infinity | 0.300 | glass | 1.517 | 64.17 |
| 10 | | infinity | 0.326 | | | |
| 11 | Image | infinity | — | | | |
| | plane | | | | | |

TABLE 12
Aspheric Coefficients

| surface | 2 | 3 | 5 | 6 | 7 | 8 |
|---|---|---|---|---|---|---|
| K: | 5.2732E+00 | 2.0909E+01 | −9.5305E−01 | −5.6895E+00 | −2.4514E+00 | −7.6091E−02 |
| A: | 3.3414E−01 | 8.4239E−01 | −7.7180E−02 | −1.4036E+00 | 2.0463E−03 | 7.0750E−02 |
| B: | 2.7099E−01 | −7.1657E−01 | 1.1784E+00 | 2.7424E+00 | −9.5297E−02 | −2.4395E−01 |
| C: | −2.4011E+00 | 4.4395E+01 | −9.3653E+00 | −5.9797E+00 | −1.1786E−01 | −4.2916E−02 |
| D: | 1.0078E+01 | −2.3174E+02 | 6.3816E+01 | 5.0229E+00 | −8.2333E−03 | 1.1159E−01 |
| E: | −3.5750E+00 | 1.3698E+02 | −2.8006E+02 | 2.7918E−01 | 7.3641E−02 | 1.7417E−02 |
| F | −3.8559E+01 | 1.0939E+03 | 8.6338E+02 | −2.1985E+00 | 7.8696E−02 | −8.2864E−02 |
| G | 5.4058E+01 | 9.4539E+03 | −1.2923E+03 | −2.9416E+00 | −2.0725E−01 | 3.1924E−02 |

In the sixth embodiment, the equation of the aspheric surface profiles of the aforementioned lens elements is the same as the equation of the first embodiment. Also, the definitions of these parameters shown in the following table are the same as those stated in the first embodiment with corresponding values for the sixth embodiment, so an explanation in this regard will not be provided again.

Moreover, these parameters can be calculated from Table 11 and Table 12 as the following values and satisfy the following conditions:

Embodiment 6

| | | | |
|---|---|---|---|
| f[mm] | 1.57 | f12/f3 | 0.09 |
| Fno | 2.1 | f/TL | 0.46 |
| FOV[deg.] | 74.88 | R1/R2 | 1.26 |
| f/f12 | 0.81 | R3/R4 | 2.36 |
| f/f23 | 1.10 | R5/R6 | 1.02 |
| f1/f2 | −14.86 | CT1/CT2 | 0.62 |
| f2/f3 | 0.08 | CT2/CT3 | 1.23 |
| f1/f3 | −1.16 | CT1/CT3 | 0.76 |
| f1/f23 | −18.15 | | |

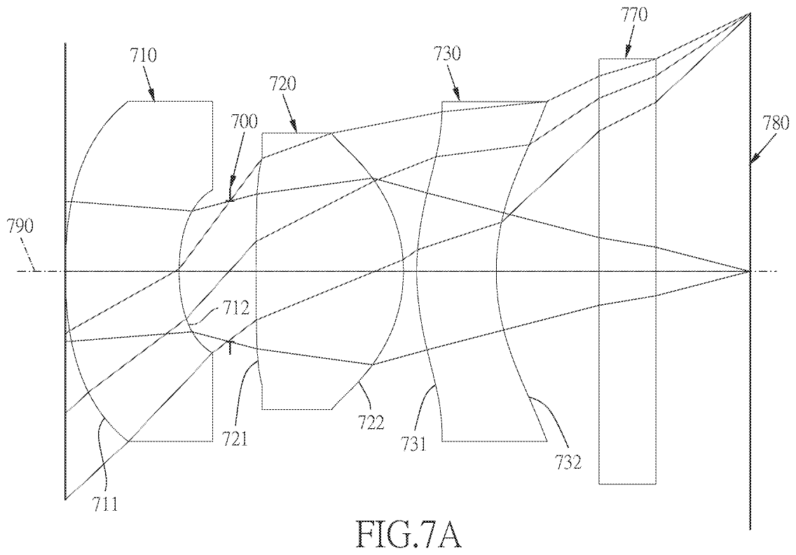

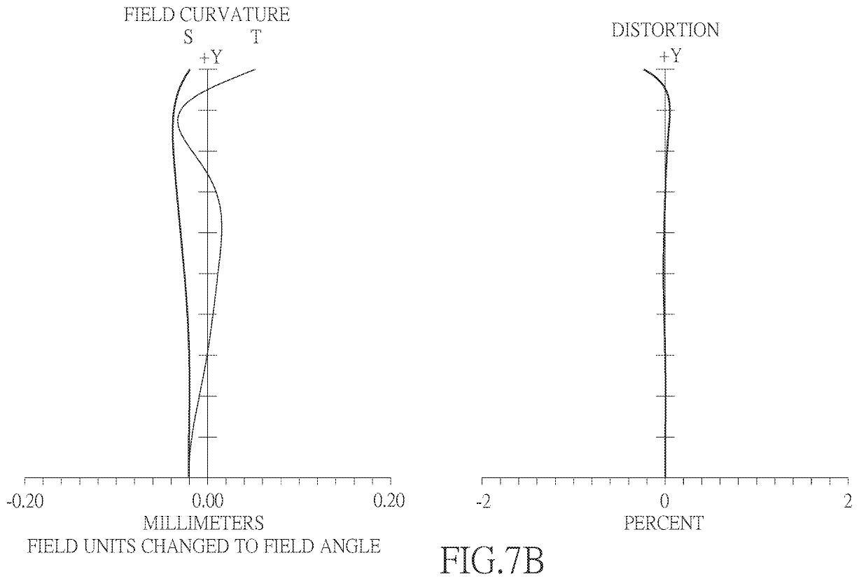

Referring to FIGS. 7A and 7B, FIG. 7A shows a three-piece infrared single wavelength lens system in accordance with a seventh embodiment of the present invention, and FIG. 7B shows, in order from left to right, the image plane curve and the distortion curve of the seventh embodiment of the present invention. A three-piece infrared single wavelength lens system in accordance with the seventh embodiment of the present invention comprises a stop 700 and a lens group. The lens group comprises, in order from an object side to an image side: a first lens element 710, a second lens element 720, a third lens element 730, an IR cut filter 770, and an image plane 780, wherein the three-piece infrared single wavelength lens system has a total of three lens elements with refractive power. The stop 700 is disposed between the first lens element 710 and the second lens element 720.

The first lens element 710 with a negative refractive power has an object-side surface 711 being convex near an optical axis 790 and an image-side surface 712 being concave near the optical axis 790, the object-side surface 711 and the image-side surface 712 are aspheric, and the first lens element 710 is made of plastic material.

The second lens element 720 with a positive refractive power has an object-side surface 721 being concave near the optical axis 790 and an image-side surface 722 being convex near the optical axis 790, the object-side surface 721 and the image-side surface 722 are aspheric, and the second lens element 720 is made of plastic material.

The third lens element 730 with a positive refractive power has an object-side surface 731 being convex near the optical axis 790 and an image-side surface 732 being concave near the optical axis 790, the object-side surface 731 and the image-side surface 732 are aspheric, the third lens element 730 is made of plastic material, and at least one of the object-side surface 731 and the image-side surface 732 is provided with at least one inflection point.

The IR cut filter 770 made of glass is located between the third lens element 730 and the image plane 780 and has no influence on the focal length of the three-piece infrared single wavelength lens system.

The detailed optical data of the seventh embodiment is shown in table 13, and the aspheric surface data is shown in table 14.

TABLE 13
Embodiment 7
f(focal length) = 1.46 mm, Fno = 2.0, FOV = 84.9 deg.

| | | Curvature | | | | | | Focal |
|---|---|---|---|---|---|---|---|---|
| surface | | Radius | | Thickness | Material | Index | Abbe # | length |
| 0 | object | infinity | | infinity | | | | |
| 1 | | infinity | | 0 | | | | |
| 2 | Lens 1 | 2.268 | (ASP) | 0.604 | plastic | 1.54 | 56 | −26.05 |
| 3 | | 0.942 | (ASP) | 0.270 | | | | |
| 4 | stop | infinity | | 0.138 | | | | |
| 5 | Lens 2 | 17.583 | (ASP) | 0.782 | plastic | 1.63 | 23.9 | 1.75 |
| 6 | | −0.817 | (ASP) | 0.070 | | | | |
| 7 | Lens 3 | 1.391 | (ASP) | 0.422 | plastic | 1.54 | 56 | 22.37 |
| 8 | | 1.235 | (ASP) | 0.546 | | | | |

| | | | | | | |
|---|---|---|---|---|---|---|
| 9 | IR-filter | infinity | 0.300 | glass | 1.517 | 64.17 |
| 10 | | infinity | 0.501 | | | |
| 11 | Image | infinity | — | | | |
| | plane | | | | | |

TABLE 14
Aspheric Coefficients

| surface | 2 | 3 | 5 | 6 | 7 | 8 |
|---|---|---|---|---|---|---|
| K: | −9.7413E+00 | 3.1682E+00 | 1.0001E+02 | −5.3455E+00 | −3.2823E+00 | 2.7202E−01 |
| A: | 3.1137E−01 | 8.2309E−01 | 3.7344E−03 | −1.3292E+00 | −6.1724E−02 | 1.4826E−01 |
| B: | −1.0515E−02 | −1.4297E+00 | 1.1470E+00 | 2.6637E+00 | −3.0264E−01 | −1.0266E+00 |
| C: | −7.6675E−01 | 1.6638E+01 | −1.3918E+01 | −5.7517E+00 | 7.3444E−01 | 1.4292E+00 |
| D: | 3.6057E+00 | 2.6176E+00 | 9.0309E+01 | 7.6743E+00 | −8.3905E−01 | −1.2264E+00 |
| E: | −7.0811E+00 | 2.3399E+02 | −2.7074E+02 | 1.6806E+00 | −2.0145E+00 | 2.5782E−02 |
| F | 6.7095E+00 | −4.7000E+03 | 4.0328E+02 | −2.6807E+01 | 5.1297E+00 | 8.7831E−01 |
| G | −2.4452E+00 | 1.9814E+04 | −2.4640E+02 | 3.4028E+01 | −2.8834E+00 | −4.9463E−01 |

In the seventh embodiment, the equation of the aspheric surface profiles of the aforementioned lens elements is the same as the equation of the first embodiment. Also, the definitions of these parameters shown in the following table are the same as those stated in the first embodiment with corresponding values for the seventh embodiment, so an explanation in this regard will not be provided again.

Moreover, these parameters can be calculated from Table 13 and Table 14 as the following values and satisfy the following conditions:

Embodiment 7

| | | | |
|---|---|---|---|
| f[mm] | 1.46 | f12/f3 | 0.003 |
| Fno | 2.0 | f/TL | 0.40 |
| FOV[deg.] | 84.90 | R1/R2 | 2.41 |
| f/f12 | 0.88 | R3/R4 | −21.53 |
| f/f23 | 1.30 | R5/R6 | 1.13 |
| f1/f2 | −2.46 | CT1/CT2 | 0.77 |
| f2/f3 | 0.002 | CT2/CT3 | 1.85 |
| f1/f3 | −0.01 | CT1/CT3 | 1.43 |
| f1/f23 | −2.79 | | |

In the present three-piece infrared single wavelength lens system, the lens elements can be made of plastic or glass. If the lens elements are made of plastic, the cost will be effectively reduced. If the lens elements are made of glass, there is more freedom in distributing the refractive power of the three-piece infrared single wavelength lens system. Plastic lens elements can have aspheric surfaces, which allow more design parameter freedom (than spherical surfaces), so as to reduce the aberration and the number of the lens elements, as well as the total track length of the three-piece infrared single wavelength lens system.

In the present three-piece infrared single wavelength lens system, if the object-side or the image-side surface of the lens elements with refractive power is convex and the location of the convex surface is not defined, the object-side or the image-side surface of the lens elements near the optical axis is convex. If the object-side or the image-side surface of the lens elements is concave and the location of the concave surface is not defined, the object-side or the image-side surface of the lens elements near the optical axis is concave.

The three-piece infrared single wavelength lens system of the present invention can be used in focusing optical systems and can obtain better image quality. The three-piece infrared single wavelength lens system of the present invention can also be used in electronic imaging systems, such as, 3D image capturing, digital camera, mobile device, digital flat panel or vehicle camera.

While we have shown and described various embodiments in accordance with the present invention, it should be clear to those skilled in the art that further embodiments may be made without departing from the scope of the present invention.

What is claimed is:

1. A three-piece infrared lens system, in order from an object side to an image side, comprising:
a first lens element with a negative refractive power, having an object-side surface being convex near an optical axis and an image-side surface being concave near the optical axis, at least one of the object-side surface and the image-side surface of the first lens element being aspheric;
a stop;
a second lens element with a positive refractive power, having an image-side surface being convex near the optical axis, at least one of an object-side surface and the image-side surface of the second lens element being aspheric; and
a third lens element with a refractive power, having an object-side surface being convex near the optical axis and an image-side surface being concave near the optical axis, at least one of the object-side surface and the image-side surface of the third lens element being aspheric;
wherein a focal length of the second lens element is f2, a focal length of the third lens element is f3, and they satisfy the relation: 0.002≤f2/f3≤0.26 or f2/f3=−0.02;
wherein a focal length of the three-piece infrared lens system is f, a distance from the object-side surface of the first lens element to an image plane along the optical axis is TL, and they satisfy the relation: 0.39≤f/TL<0.6.

2. The three-piece infrared lens system as claimed in claim 1, wherein a focal length of the three-piece infrared lens system is f, a focal length of the first lens element and the second lens element combined is f12, and they satisfy the relation: 0.5<f/f12<1.1.

3. The three-piece infrared lens system as claimed in claim 1, wherein a focal length of the three-piece infrared lens system is f, a focal length of the second lens element and the third lens element combined is f23, and they satisfy the relation: 0.8<f/f23<1.6.

4. The three-piece infrared lens system as claimed in claim 1, wherein a focal length of the first lens element is f1, a focal length of the second lens element is f2, and they satisfy the relation: −19<f1/f2<−1.4.

5. The three-piece infrared lens system as claimed in claim 1, wherein a focal length of the first lens element is f1, a focal length of the third lens element is f3, and they satisfy the relation: −1.5<f1/f3<0.07.

6. The three-piece infrared lens system as claimed in claim 1, wherein a focal length of the first lens element is f1, a focal length of the second lens element and the third lens element combined is f23, and they satisfy the relation: −23<f1/f23<−1.9.

7. The three-piece infrared lens system as claimed in claim 1, wherein a focal length of the first lens element and the second lens element combined is f12, a focal length of the third lens element is f3, and they satisfy the relation: −0.05<f12/f3<0.37.

8. The three-piece infrared lens system as claimed in claim 1, wherein a radius of curvature of the image-side surface of the first lens element is R1, a radius of curvature of the image source-side surface of the first lens element is R2, and they satisfy the relation: 0.9<R1/R2<5.3.

9. The three-piece infrared lens system as claimed in claim 1, wherein a radius of curvature of the image-side surface of the second lens element is R3, a radius of curvature of the image source-side surface of the second lens element is R4, and they satisfy the relation: −27<R3/R4<27.

10. The three-piece infrared lens system as claimed in claim 1, wherein a radius of curvature of the image-side surface of the third lens element is R5, a radius of curvature of the image source-side surface of the third lens element is R6, and they satisfy the relation: 0.7<R5/R6<1.5.

11. The three-piece infrared lens system as claimed in claim 1, wherein a central thickness of the first lens element along the optical axis is CT1, a central thickness of the second lens element along the optical axis is CT2, and they satisfy the relation: 0.5<CT1/CT2<1.1.

12. The three-piece infrared lens system as claimed in claim 1, wherein a central thickness of the second lens element along the optical axis is CT2, a central thickness of the third lens element along the optical axis is CT3, and they satisfy the relation: 0.9<CT2/CT3<2.4.

13. The three-piece infrared lens system as claimed in claim 1, wherein a central thickness of the first lens element along the optical axis is CT1, the central thickness of the third lens element along the optical axis is CT3, and they satisfy the relation: 0.6<CT1/CT3<1.8.
